(19) United States
(12) Patent Application Publication
(10) Pub. No.: US 2011/0016881 A1
(43) Pub. Date: Jan. 27, 2011

(54) GAS TURBINE WITH EXHAUST GAS CASING AND METHOD FOR PRODUCING A GAS TURBINE

(76) Inventors: Jose Luis Ruiz, Greenacres, FL (US); Orestes Jesus Maurell, West Palm Beach, FL (US); Kevin Brady Powell, Jupiter, FL (US); Harold Richard Siegert, JR., Jupiter, FL (US); Kevin Damian Carpenter, Palm Beach Gardens, FL (US)

Correspondence Address: CERMAK NAKAJIMA LLP, 127 S. Peyton Street, Suite 210, ALEXANDRIA, VA, 22314, US

(21) Appl. No.: 12/616,272

(22) Filed: Nov. 11, 2009

Related U.S. Application Data
(60) Provisional application No. 61/227,161, filed on Jul. 21, 2009.

(51) Int. Cl. F02C 7/20; B23P 11/00

(52) U.S. Cl. 60/796; 29/889.22

(57) ABSTRACT

A gas turbine (10) has an annular exhaust gas casing (16) which is arranged at the outlet of the turbine at a distance from the supporting foundation (22) and includes an outer shell (20a). Sagging of the exhaust gas casing (16) is avoided by supporting devices (26, 27, 28), each with a predetermined supporting direction, being arranged between the foundation (22) and the outer shell (20a) of the exhaust gas casing (16) for absorbing deformations of the exhaust gas casing (16), which are fastened by one end on the outer shell (20a) of the exhaust gas casing (16) and supported by the other end on the foundation (22), and by each of the supporting devices (26, 27, 28) having a pre-loaded spring support (30) which acts in a supporting direction.

This application claims priority under 35 U.S.C. §119 to U.S. Provisional application No. 61/227,161, filed 21 Jul. 2009, the entirety of which is incorporated by reference herein.

### BACKGROUND

1. Field of Endeavor

The present invention relates to the field of gas turbine technology, to a gas turbine with an annular exhaust gas casing which is arranged at the outlet of the turbine at a distance from the supporting foundation, and to a method for its production.

2. Brief Description of the Related Art

For a long time, large stationary gas turbines have proved successful in power generation in combined cycle power plants or in another environment (see, for example, D. K. Mukherjee, State-of-the-art gas turbines—a brief update, ABB Review 2/1997, p. 4-14 (1997)). One of the gas turbines constructed there, the GT13E2 with an output of 165 MW, is reproduced in FIG. 1 in a partially sectioned perspective view.

The gas turbine 10 from FIG. 1 includes a rotor which is rotatably mounted around a machine axis 49, with a rotor shaft 17 and blading which, on the one hand, is part of a compressor 11 for the inducted combustion air and, on the other hand, is part of a turbine 14 for expanding the hot gas which is produced. Between compressor 11 and turbine 14 a combustion chamber 13 is arranged, into which an annular arrangement of burners 12 injects a fuel-air mixture for combustion. The combustion chamber 13 and the subsequent turbine 14 are enclosed by an outer casing 15 to which an annular exhaust gas casing 16 is flanged. The exhaust gas casing 16, which is shown in FIG. 2 in its details, includes an outer shell 20a and an inner shell 20b in a concentric arrangement and interconnected by radially oriented struts 21 which are arranged in a distributed manner around the periphery.

As a stationary turbine, the gas turbine 10 is built on a stable foundation (22 in FIG. 2) and in the outlet region is supported on a bearing pedestal 23 by supports (not shown in FIG. 2) which act upon the outer casing 15. The exhaust gas casing 16 itself is not supported in the prior art. On account of the compactness and the weight of the exhaust gas casing 16, sagging of the casing can possibly occur, which can lead to decentralizing of the bearing and to rubbing of the rotor blades. There thus remains a need to safely exclude such sagging in the case of such casing configurations.

### SUMMARY

One of numerous aspects of the present invention includes a gas turbine which can avoid the aforementioned disadvantages of previous gas turbines and can be characterized by increased stability of the casing in the exhaust gas region, which can also be subsequently brought about in a simple manner in already existing gas turbines, and also methods for producing or installing such gas turbines.

Another aspect of the present invention relates to absorbing deformations of the exhaust gas casing with supporting devices, with a predetermined supporting direction in each case, which are arranged between the foundation and the outer shell of the exhaust gas casing and are fastened by one end on the outer shell of the exhaust gas casing and supported by the other end on the foundation, so that the supporting devices in each case have a pre-loaded spring support which acts in the supporting direction.

A further development relates to a plurality of supporting devices provided with different supporting directions which are arranged symmetrically to a vertical center plane which runs through the machine axis.

Three separate supporting devices are preferably provided, of which the center supporting device lies in the vertical center plane which runs through the machine axis, while the two other supporting devices have supporting directions which, by an angle of between 30° and 40°, preferably of about 36°, are inclined from the vertical center plane which runs through the machine axis.

In order to absorb thermal expansions it is advantageous in this case if, in the cold state of the gas turbine, the supporting direction of the center supporting device is inclined from the vertical by a few degrees, preferably 6.9°, and the supporting directions of the two other supporting devices are inclined from the radial direction by a few degrees, preferably 6°.

Another development includes that the supporting devices are pivotably connected by their ends to the outer shell of the exhaust gas casing and to the foundation for absorbing thermal expansions.

A further development is characterized in that a foundation plate is fastened on the upper side of the foundation, and that a baseplate, which for each of the supporting devices carries a corresponding support block which is matched to the respective supporting direction, is arranged on the foundation plate, and that the supporting devices are pivotably connected to the support blocks.

In order to pivotably connect the supporting devices to the support blocks, a fork-head jackscrew is especially provided, wherein the fork-head jackscrew is mounted in the support block in a displaceable manner in the supporting direction and supported on the support block via support devices which are adjustable in the supporting direction relative to the fork-head jackscrew.

Another development includes that the fork-head jackscrews are each provided with a male thread, and the support devices each include a locking ring which, by a corresponding female thread, is screwed onto the fork-head jackscrew.

Devices for hydraulic pre-loading of the supporting devices are preferably provided in each of the support blocks.

The hydraulic pre-loading devices especially include access openings in the support blocks into which a hydraulic piston can be inserted for hydraulic displacement of the fork-head jackscrews in the supporting direction.

According to another development, the spring supports are formed as angulating spring supports.

A further development includes that, for each of the supporting devices, provision is made for an adapter block which abuts against, and is fastened on, the outer shell of the exhaust gas casing, and the supporting devices are pivotably connected to the adapter blocks.

An exemplary method embodying principles of the present invention for producing a gas turbine is characterized in that, in a first step, means for fastening the supporting devices are installed on the foundation and on the outer shell of the exhaust gas casing, in that in a second step the supporting devices are connected without pre-loading to the fastening means, in that in a third step the supporting devices are pre-loaded, and in that in a fourth step the supporting devices are fixed in the pre-loaded state.

In this case, the procedure is preferably carried out so that in the first step the fastening means are fastened by screws on the foundation and on the outer shell of the exhaust gas casing, and so that in the third step the supporting devices are hydraulically pre-loaded by an insertable hydraulic piston.

In the fourth step, the fixing of the supporting devices in the pre-loaded state is especially carried out by rotating a locking ring which is seated on a thread.

### BRIEF DESCRIPTION OF THE DRAWINGS

The invention shall subsequently be explained in more detail based on exemplary embodiments in conjunction with the drawing. In the drawing

FIG. 1 shows in a partially sectioned perspective view an exemplary gas turbine (GT13E2), as is suitable for the application of the invention;

FIG. 2 shows the outlet-side part of the gas turbine from FIG. 1 with the associated foundation and an additional support of the exhaust gas casing according to an exemplary embodiment of the invention;

FIG. 3 shows an enlarged view of the additional support from FIG. 2 as seen in the direction of the machine axis;

FIG. 4 shows, in an enlarged detail from FIG. 3, the connection between foundation plate and baseplate of the additional support;

FIG. 5 shows, in an enlarged detail from FIG. 3, the pivotable connection of the right-hand supporting device to the outer shell of the exhaust gas casing;

FIG. 6 shows, in an enlarged detail from FIG. 3, the pivotable and adjustable connection of the center supporting device to the associated support block;

FIG. 7 shows, in an enlarged detail from FIG. 3, the pivotable and adjustable connection of the right-hand supporting device to the associated support block;

FIG. 8 shows the fork-head jackscrew and the associated locking ring of the center supporting device from FIG. 3;

FIG. 9 shows the fork-head jackscrew and the associated locking ring of the side supporting devices from FIG. 3;

FIG. 10 shows the inclination of the supporting devices from the radial direction in the case of the additional support according to FIG. 2 or 3;

FIG. 11 shows the procedure when pre-loading the center supporting device from FIG. 3;

FIG. 12 shows the procedure when pre-loading the right-hand supporting device from FIG. 3; and

FIG. 13 shows, as a variant of FIG. 10, the fastening of the adapter block of the supporting device with a plurality of flange clamps.

### DETAILED DESCRIPTION OF EXEMPLARY EMBODIMENTS

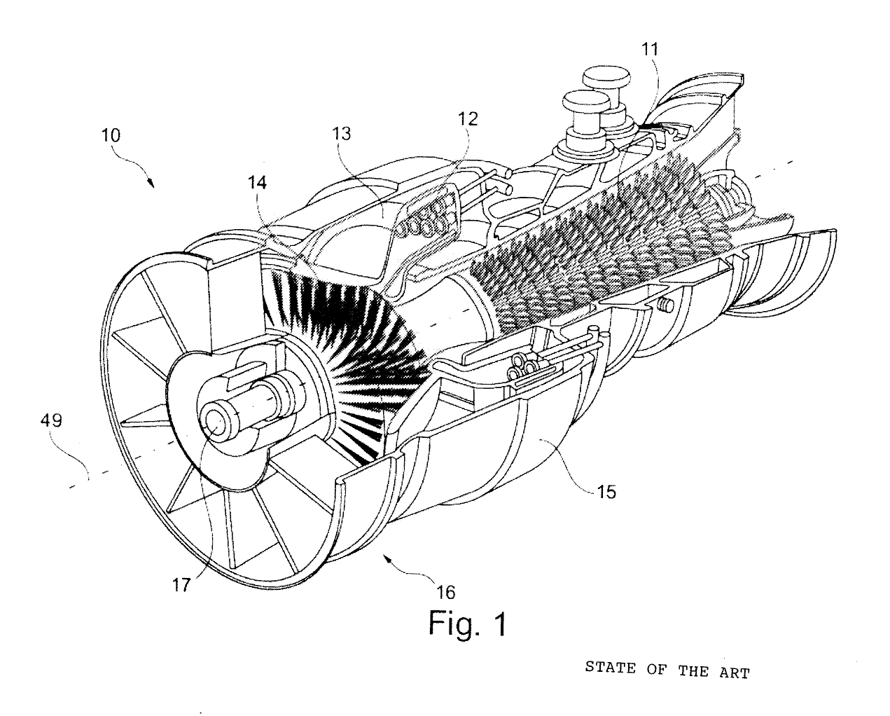

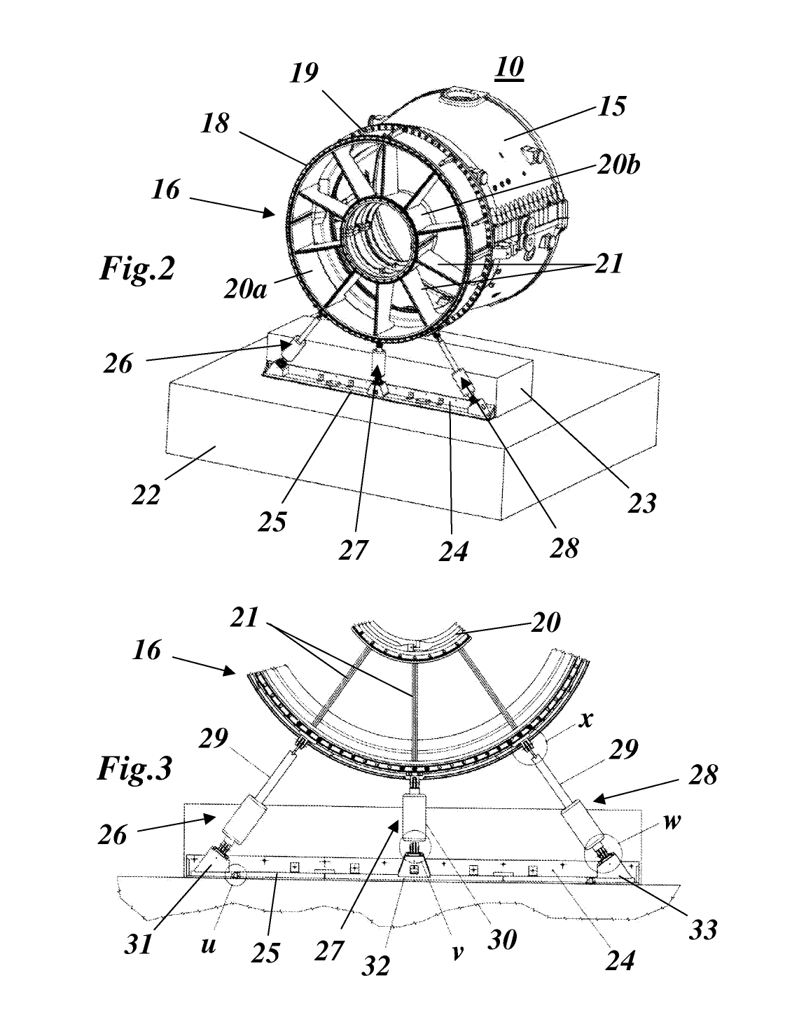

In FIG. 2, the outlet-side part of the gas turbine from FIG. 1 with the associated foundation and an additional support of the exhaust gas casing according to an exemplary embodiment of the invention is reproduced. Of the gas turbine 10, only the outer casing 15, which encloses the turbine and a part of the combustion chamber, and also the exhaust gas casing 16, which follows in the direction of flow, are shown for greater clarity. For the exhaust gas casing 16 which in earlier gas turbines is unsupported, provision is now made here for three supporting devices 26, 27, and 28 which act in a specific supporting direction in each case and support the exhaust gas casing 16 against the underlying foundation 22 of the gas turbine 10 and so prevent a noticeable sagging of the heavy casing.

The three supporting devices 26, 27 and 28 preferably lie in each case in a plane which is defined by corresponding radial struts 21 between the inner shell 20b and the outer shell 20a of the exhaust gas casing 16. They are arranged and oriented at the same time symmetrically to a vertical center plane which runs through the machine axis 49. The planes of the side supporting devices 26 and 28 with the center plane include an angle of 36° in each case. The supporting devices 26, 27 and 28 in each case establish a supporting direction which is inclined downstream from the radial direction. In the case of the center supporting device 27, the angle of inclination in the cold state of the machine is preferably 9.6° and at operating temperature increases by 1.7°. In the case of the side supporting devices 26 and 28, the angle of inclination is preferably 6° and at operating temperature increases by 0.9°. Other machine dimensions in this case require other angles of inclination.

Each of the supporting devices 26, 27, 28, which are of different length for geometric reasons, contain a spring support 30 which acts in the supporting direction and is formed as an angulating spring support. In business, such spring supports are commercially obtainable. A suitable type for example is the type 20-91-14 of the Lisega Company, which can provide up to 100 kN of spring force with a spring constant of 1333 N/mm. In the case of the center supporting device 27, the spring support 30 can be used directly, in the case of the side supporting devices 26, 28 the spring support is used with an extension in each case (29 in FIG. 3 or 38 in FIG. 12).

The supporting devices 26, 27, 28 are pivotably connected in the axial direction to associated adapter blocks 40 (FIGS. 5, 10) on the exhaust gas casing 16 in order to be able to follow thermal expansions of the exhaust gas casing 16 without any problem. On the foundation side, the supporting devices 26, 27, 28 are likewise pivotably connected in the axial direction to associated support blocks 31, 32, 33. The adapter blocks 40 are arranged on the outer side of the outer shell 20a of the exhaust gas casing 16 between the inlet-side flange 19 and an outlet-side flange 18 and fastened by a bolted connection 43. The adapter blocks are adapted to the curvature of the outer shell 20a. A fork head 39 (FIGS. 5, 10), to which the supporting device 26, 27, 28 is connected by a hinge bolt 37, is fastened (for example welded) on each adapter block 40.

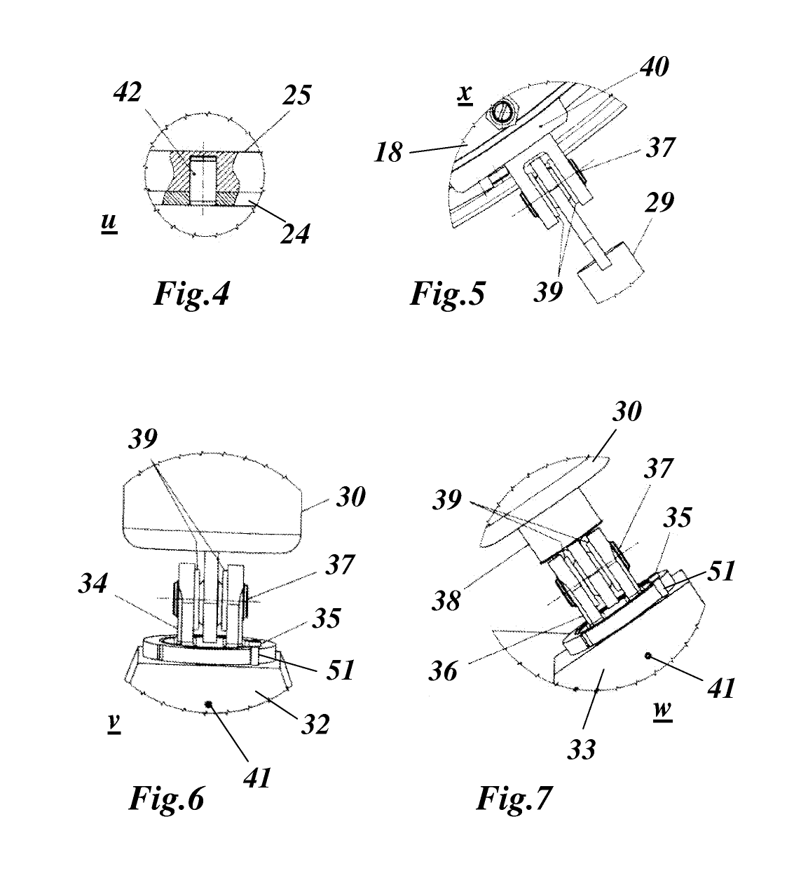

On the foundation side, the corresponding pivot connections are constructed as follows: a foundation plate 24, which is formed as a rectangular angle strip, is fastened in the corner which is located downstream between foundation 22 and bearing pedestal 23. A reinforced baseplate 25 which is fixed on the foundation plate 24 by fixing pins 42 (FIG. 4) lies parallel to the surface of the foundation 22. Three support blocks 31, 32 and 33 are fastened on the baseplate. The support block 32 which is provided for the center supporting device 27 has a horizontal surface. The two support blocks 31 and 33 which are provided for the side supporting devices 26 and 28 have a bevelled surface which is inclined by ±36° and is adapted to the respective supporting direction.

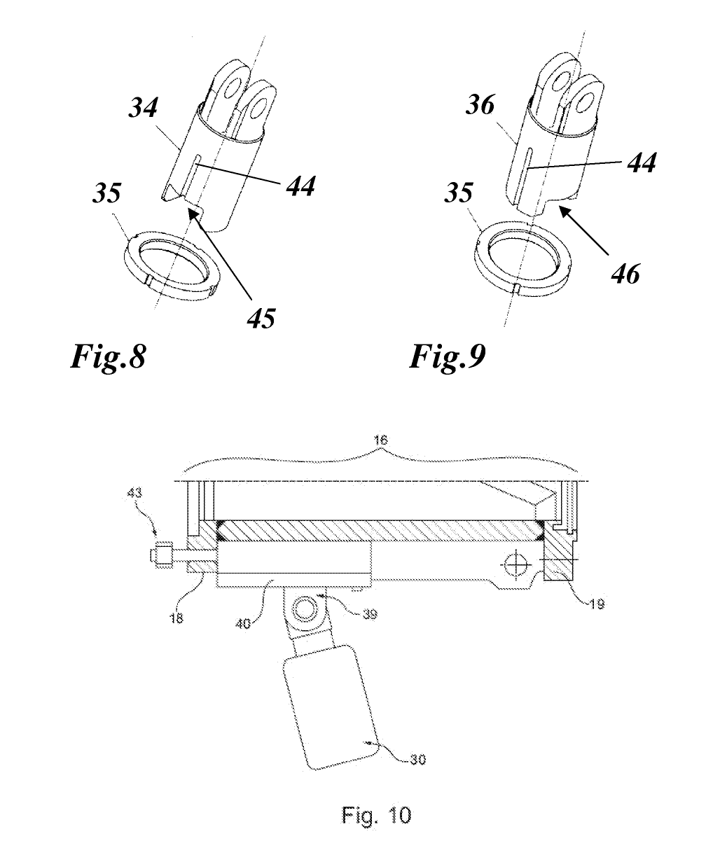

A bore, which accommodates a fork-head jackscrew 34 or 36 of the type which is shown in FIG. 8 or FIG. 9, is introduced in the support blocks 31, 32 and 33 in each case perpendicularly to the upper side. The fork-head jackscrew 34 of the type which is shown in FIG. 8 is provided for the support block 32 of the center supporting device 27; the fork-head jackscrew 36 of the type which is shown in FIG. 9 is provided for the support blocks 31 and 33 of the side supporting devices 26 or 28. The fork-head jackscrews 34, 36 carry a male thread and at the side have a guide slot 44 which extends in the axial direction and corresponds to a guide pin 41 (FIGS. 6, 7) which is inserted in the support blocks 31, 32, 33 and projects laterally into the bore and guides the fork-head jackscrews 34, 36 in a rotation-resisting manner.

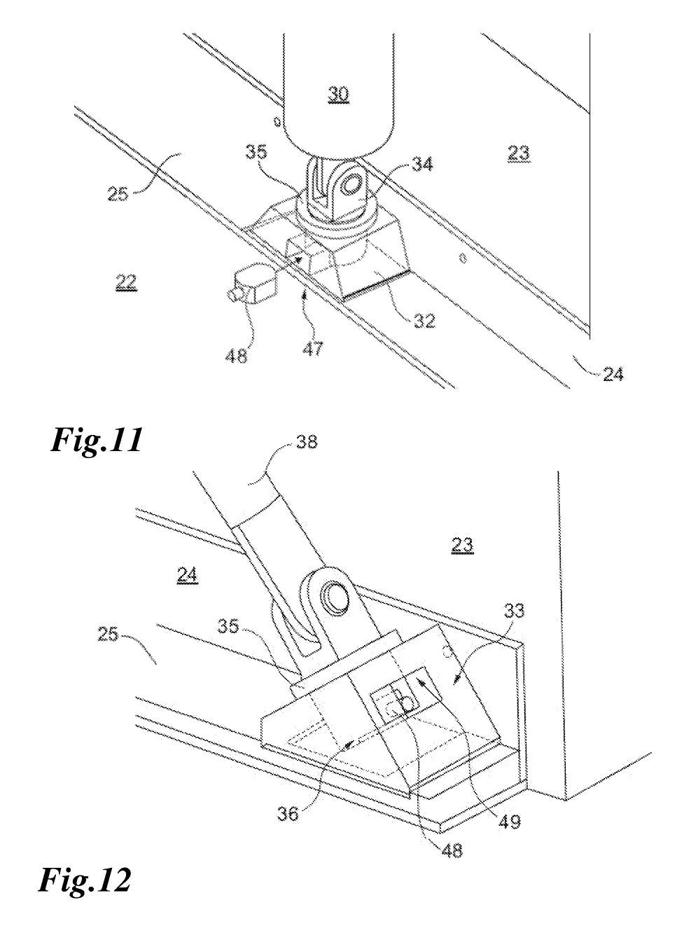

Associated with each of the fork-head jackscrews 34, 36 is a locking ring 35 with female thread, which can be screwed onto the fork-head jackscrews 34, 36. Furthermore, the fork-head jackscrews 34, 36 at the lower end have a transversely extending recess 45 or 46 with rectangular cross-sectional contour, which serve for accommodating a hydraulic piston (48 in FIGS. 11, 12). The two recesses 45 and 46 are rotated relative to each other by 90° because, in the case of the center support block 32, the hydraulic piston 48 is inserted from the front (FIG. 11) while, in the case of the side support blocks 31, 33, it is inserted from the side (FIG. 12).

The upper end of the fork-head jackscrews 34, 36 is formed as a fork head 39 to which are connected the supporting devices 26, 27, 28 by a hinge bolt 37 (FIGS. 6, 7). The fork-head jackscrews 34, 36 are displaceably mounted in the supporting direction in the bore in the associated support block 31, 32, 33 and are supported on the upper side of the respective support block 31, 32, 33 via the screwed-on locking ring 35 (FIGS. 6, 7).

When installing the supporting devices, as is shown in FIGS. 11 and 12, the supporting devices are first of all connected to the adapter blocks 40 and to the fork-head jackscrews 34, 36 which are seated in the support blocks 31, 32, 33, without pre-loading of the spring support 30. Then, via access openings 47 or 49 in the support blocks 31, 32, 33, a hydraulic piston 48 is inserted into the recesses 45, 46 at the lower end of the fork-head jackscrews 34, 36. By highly-pressurizing the hydraulic piston 48 in the supporting direction the fork-head jackscrew 34, 36 is partially forced out of the bore and compresses and therefore pre-loads the associated spring support 30 of the supporting device. The pre-loading which is created can be calculated by reading off the hydraulic pressure and multiplying it using the effective hydraulic surface of the hydraulic piston 48. In the pre-loaded state, the locking ring 35 is then screwed down until it abuts against the upper side of the support block and is subsequently secured by a locking bolt 51. If the pressure is then removed from the hydraulic piston 48 the pre-loaded supporting device is supported on the support block via the locking ring. In this way, the necessary pre-loading can be individually set for each of the supporting devices 26, 27, 28.

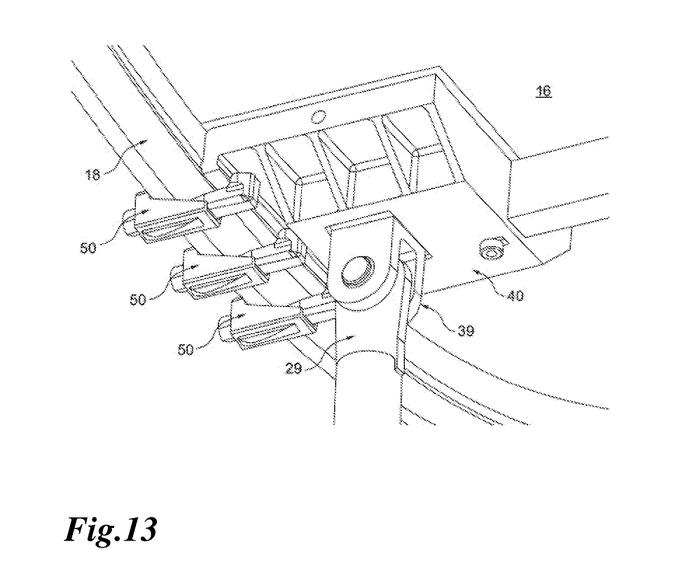

Instead of the bolted connection 43 shown in FIG. 10, it is however also possible according to FIG. 13 to use a plurality of flange clamps 50 to fasten the correspondingly adapted adapter block 40 to the flange 18. The flange clamps 50 are provided in any case if the exhaust-gas diffuser section which is fitted to the exhaust gas casing 16 at the downstream side is flanged to the flange 18 using such flange clamps.

The advantages of the invention are multifarious and include:
At prespecified vital points of the casing, an individual adjustable force which counteracts the sagging can be exerted on the casing.
The force permanently stays in effect thanks to the pre-loaded spring support.
The forces are reliably directed into the foundation.
The pivot connection between casing and foundation on the one hand and the supporting device on the other hand neutralize thermal expansions of the machine.
The construction and installation of the supporting devices is very simple.
The installation can be subsequently undertaken from the outside because dismantling or partial dismantling of the machine is not necessary.
Commercially available components can be used which makes the solution altogether cheaper.

List Of Designations
10 Gas turbine (for example GT13E2)
11 Compressor
12 Burner
13 Combustion chamber
14 Turbine
15 Outer casing
16 Exhaust gas casing
17 Rotor shaft
18, 19 Flange
20a Outer shell (exhaust gas casing)
20b Inner shell (exhaust gas casing)
21 Strut
22 Foundation
23 Bearing pedestal
24 Foundation plate
25 Baseplate
26, 27, 28 Supporting device
29, 38 Extension (spring support)
Spring support (for example Lisega type 20-19)
31, 32, 33 Support block
34, 36 Fork-head jackscrew
35 Locking ring
37 Hinge bolt
39 Fork head
40 Adapter block
41 Guide pin
42 Fixing pin
43 Bolted connection
44 Guide slot
45, 46 Recess
47, 49 Access opening
48 Hydraulic piston
49 Machine axis
50 Flange clamp
51 Locking bolt

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

We claim:

1. A gas turbine comprising:
a supporting foundation;
a turbine outlet;
an annular exhaust gas casing arranged at the turbine outlet at a distance from the supporting foundation and comprising an outer shell;
supporting devices configured and arranged to absorb deformations of the exhaust gas casing, each supporting device defining a predetermined supporting direction, the supporting devices being arranged between the foundation and the exhaust gas casing outer shell and each having a first end fastened on the exhaust gas casing outer shell and having a second end on the foundation; and
wherein each of the supporting devices comprises a pre-loaded spring support which acts in said supporting direction.

2. The gas turbine as claimed in claim 1, wherein the gas turbine defines a machine axis, and wherein the supporting devices together define different supporting directions which are arranged symmetrically relative to a vertical center plane which runs through the machine axis.

3. The gas turbine as claimed in claim 2, wherein the supporting devices comprise three separate supporting devices, including a center supporting device which lies in said vertical center plane and two other supporting devices which each have a supporting direction inclined from said vertical center plane by an angle of between 30° and 40°.

4. The gas turbine as claimed in claim 3, wherein said angle is about 36°.

5. The gas turbine as claimed in claim 3, wherein, when the gas turbine is in a cold state, the supporting direction of the center supporting device is inclined from vertical, and the supporting directions of the two other supporting devices are inclined from the radial direction.

6. The gas turbine as claimed in claim 3, wherein, when the gas turbine is in a cold state, the supporting direction of the center supporting device is inclined from vertical by 9.6°, and the supporting directions of the two other supporting devices are inclined from the radial direction by 6°.

7. The gas turbine as claimed in claim 1, wherein the supporting devices are pivotably connected by said ends to the exhaust gas casing outer shell and to the foundation for absorbing thermal expansions.

8. The gas turbine as claimed in claim 7, further comprising:
a foundation plate fastened on an upper side of the foundation;
a baseplate comprising a support block for each of the supporting devices, each support block being matched to a respective supporting direction, the baseplate being arranged on the foundation plate; and
wherein the supporting devices are pivotably connected to the support blocks.

9. The gas turbine as claimed in claim 8, further comprising:
fork-head jackscrews configured and arranged to pivotably connect each of the supporting devices to one of the support blocks, wherein each of the fork-head jackscrews is displaceably mounted in the supporting direction in a support block; and
adjustable supports configured and arranged to support the fork-head jackscrews on a support block, each adjustable supports being adjustable in the supporting direction relative to a respective fork-head jackscrew.

10. The gas turbine as claimed in claim 9, wherein each of the fork-head jackscrews comprises a male thread, and the adjustable supports each comprise a locking ring having a corresponding female thread screwed onto the fork-head jackscrew.

11. The gas turbine as claimed in claim 10, further comprising:
means for hydraulic pre-loading the supporting devices in each of the support blocks.

12. The gas turbine as claimed in claim 11, wherein the means for hydraulic pre-loading comprises access openings in the support blocks into which a hydraulic piston can be inserted for hydraulic displacement of the fork-head jackscrews in the supporting direction.

13. The gas turbine as claimed in claim 1, wherein the spring supports each comprise angulating spring supports.

14. The gas turbine as claimed in claim 7, further comprising:
an adapter block for each of the supporting devices which abuts against, and is fastened on, the exhaust gas casing outer shell; and
wherein the supporting devices are pivotably connected to the adapter blocks.

15. A method for producing a gas turbine as claimed in claim 1, the method comprising:
first installing means for fastening said supporting devices on said foundation and on said exhaust gas casing outer shell;
second connecting the supporting devices without pre-loading to said means for fastening;
third pre-loading the supporting devices; and
fourth fixing the supporting devices in the pre-loaded state.

16. The method as claimed in claim 15, wherein said installing comprises fastening the fastening means by screws on the foundation and on the exhaust gas casing outer shell; and
wherein pre-loading comprises hydraulically pre-loading the supporting devices by an insertable hydraulic piston.

17. The method as claimed in claim 15, wherein fixing comprises rotating a locking ring which is seated on a thread.
